(19) United States
(12) Patent Application Publication
(10) Pub. No.: US 2012/0062383 A1
(43) Pub. Date: Mar. 15, 2012

(54) METHOD FOR DETERMINING OPERATOR CONDITION, DEVICE THEREFROM AND THEIR USE IN ALARM RESPONSE SYSTEM IN A FACILITY

(75) Inventors: Gaurav Bhargva, Abrama Valsad (IN); Jayawant Tewari, Bangalore (IN)

(73) Assignee: ABB RESEARCH LTD, Zurich (CH)

(21) Appl. No.: 13/227,955

(22) Filed: Sep. 8, 2011

Related U.S. Application Data
(63) Continuation of application No. PCT/IB2010/000421, filed on Mar. 2, 2010.

(30) Foreign Application Priority Data
Mar. 9, 2009 (IN) 531/CHE/2009

(51) Int. Cl. G08B 23/00

(52) U.S. Cl. 340/573.1

(57) ABSTRACT

A method is disclosed for alarm distribution, the method including receiving one or more physiological parameters of one or more operators; detecting a condition of the one or more operators based on the one or more physiological parameters; deciding the condition of the one or more operators; and generating an operator alarm response based on the condition of the one or more operators. An intelligent alarm device is also disclosed that can utilize the method described herein. A processor is disclosed for intelligent alarm distribution to one or more operators determined to be in a fit condition.

### RELATED APPLICATION

This application claims priority as a continuation application under 35 U.S.C. §120 to PCT/IB2010/000421, which was filed as an International Application on Mar. 2, 2010 designating the U.S., and which claims priority to Indian Application 531/CHE/2009 filed in India on Mar. 9, 2009. The entire contents of these applications are hereby incorporated by reference in their entireties.

### FIELD

A method and a device are disclosed to detect a condition of one or more operators based on one or more physiological parameters of each of the one or more operators. A device and an alarm management system are also disclosed to decide a response for an alarm situation based on one or more operational parameters in a facility and the one or more physiological parameters of one or more operators.

### BACKGROUND INFORMATION

Operators are human beings having an assigned task of operating equipment and/or machinery. Operators may also be involved in monitoring the performance of machine, equipment, production facilities, and so on, and to ensure smooth and proper functioning thereof. An operator's responsibilities can be very critical, and include having them remain at their peak physical and mental condition during the hours of working. Situations wherein the operator is called upon to be at their peak physical and mental condition can include a situation where operator error may result in heavy financial losses and even loss of lives. It therefore is imperative that such a situation does not arise, and even if it does, appropriate steps are taken to mitigate the risks involved.

Operators, despite their own best efforts, may not be at their peak physical and mental condition at all times. This may occur in several situations, such as disturbed emotional states, even if it occurs for fleeting moments. If such a disturbed state happens to take place at the same time period as an emergency situation requiring immediate action, then the corresponding response from the aforementioned operator may not be adequate for the situation, thus resulting in heavy losses.

In an exemplary production plant facility, or an electrical power plant, several input data are obtained from various locations, some of which may not be within a certain range, and thus result in an alarm situation. If there are only a few alarm situations per day, it may be possible for the operator to handle them. However, studies conducted by The Engineering Equipment Manufacturers and Users Association (EEUMA) suggest that 150 alarms per day (one every 10 minutes) presented to an operator are “very likely to be acceptable” and 300 alarms per day (an alarm every 5 minutes) are considered “manageable”. In reality it is not unusual to record tens of thousands of alarms per operator per day. It is quite difficult for one operator to handle such volumes of alarm situations.

Known ways to mitigate this situation involves having multiple operators, and to reduce the number of alarm situations by combining different sets of input data, or by identifying nuisance alarms to help eliminate unnecessary or ineffective alarms, thus bringing the number of alarms per operator to a more manageable ratio. However, there is a limit to the number of such input data that can be combined. Further, increasing the number of operators beyond a certain number causes confusion among the operators as to the one taking responsibility.

Late night shifts for monitoring of facilities are generally considered to be most difficult, and have been identified as being most susceptible for accidents. Operators have been known to be in sub-optimal condition during this time. Several reasons have been attributed to this including circadian rhythms, regulatory bodily functions, and the like. This situation can be countered by using multiple operators, wherein at least one operator can be expected to be vigilant at any given time of the night shift.

A notable incident involving operator oversight, an excess of alarm situations, and an operator not being in a proper state to respond to alarms is the incident at Three Mile Island. Another such notable incident worthy of mention includes the An explosion at the third-largest oil refinery in the United States, the BP Texas City Refinery.

All the techniques involved during the safe, smooth and proper operation and/or monitoring of equipment and/or machinery include automated responses to emergency situations. However, it is accepted in the art that many emergency situations will involve operator intervention. All technology advances towards emergency situation responses involve minimizing the number of such situations per given time period. While it is well understood that the operator's physical and mental state is of prime importance towards handling such situations, none of the techniques provided in the art take the operator's state into account during such a situation.

### SUMMARY

A method is disclosed for alarm distribution, the method comprising; receiving one or more physiological parameters of one or more operators; detecting a condition of the one or more operators based on the one or more physiological parameters; assessing the condition of the one or more operators; and generating an operator alarm response based on an assessed condition of the one or more operators.

A process automation system is disclosed comprising: means for receiving one or more physiological parameters of one or more operators, detecting a condition of the one or more operators based on the one or more physiological parameters, and assessing the condition of the one or more operators; and means for generating an operator alarm response based on an assessed condition of the one or more operators.

An intelligent alarm device is disclosed comprising: a first sensing means for sensing one or more physiological parameters of one or more operators, the physiological parameters being representative of a condition of the one or more operators; and a processor configured to receive and process the one or more physiological parameters, and to assess the condition of the one more operators for generating an operator alarm.

An automation system is disclosed for alarm management in a facility, the automation system comprising: a first receiver module configured for receiving one or more operating parameters of the facility; a rule design module for detecting an alarm situation based on the one or more operating parameters; a second receiver module configured for receiving one or more physiological parameters of one or more operators, wherein the one or more operators monitor the one or more operating parameters of the facility in order to take corrective measures for an alarm situation; a sentient decision module for detecting a condition of one or more operators as either a fit condition or an unfit condition, and for deciding upon alarm allocation based on the condition of the operator; and an alarm distribution module for distributing an alarm response based on the condition of the one or more operators.

### BRIEF DESCRIPTION OF THE DRAWING

These and other features, aspects, and advantages of the present invention will become better understood when the following detailed description is read with reference to the accompanying drawings in which like characters represent like parts throughout the drawings, wherein:

FIG. 1 is a diagrammatic representation of an exemplary embodiment as disclosed herein, wherein an operator's face and head is fitted with physiological parameter sensing means, along with a communicating means;

FIG. 2 is a diagrammatic representation of another exemplary embodiment of the present invention, wherein an operator's hand is fitted with a physiological parameter sensing means, along with a communicating means;

FIG. 3 is a flowchart representation of an exemplary method used to determine the condition of an operator according to an exemplary disclosed embodiment;

FIG. 4 is a flowchart representation of an exemplary method used to assign responses based on the condition of an operator according to an exemplary disclosed embodiment;

FIG. 5 is a block diagram representation of an exemplary embodiment of an intelligent alarm device as disclosed herein;

FIG. 6 is a block diagram representation of an exemplary embodiment depicting an exemplary situation in a production plant; and

FIG. 7 is a block diagram representation of an exemplary embodiment of a processor as disclosed herein.

### DETAILED DESCRIPTION

A method is disclosed for alarm distribution, an exemplary method including receiving one or more physiological parameters of one or more operators; detecting a condition of the one or more operators based on the one or more physiological parameters; deciding (i.e., assessing) the condition of the one or more operators; and generating an operator alarm response based on the condition of the one or more operators.

In another aspect, an intelligent alarm device is disclosed which includes a first sensing means for sensing one or more physiological parameters of one or more operators, the physiological parameters being representative of a condition of the one or more operators; and a processor configured to receive and process the one or more physiological parameters, and further configured to decide on the condition of the one more operators.

In a further aspect, a processor is disclosed for alarm management system of a facility, the processor comprising a first receiver module configured for receiving one or more operating parameters of a facility; a second receiver module configured for receiving one or more physiological parameters of one or more operators, wherein the one or more operators monitor the one or more operating parameters of the facility in order to take corrective measures for an alarm situation; a rule design module for detecting the alarm situation based on the one or more operating parameters; a sentient decision module for detecting a condition of one or more operators as either a fit condition or an unfit condition, and for deciding an alarm allocation based on the condition of the operator; and an alarm distribution module for distributing the alarm response based on the condition of the one or more operators.

In yet another aspect, an alarm management system is disclosed for a facility which includes a first receiver module configured for receiving one or more operating parameters of a facility; a second receiver module configured for receiving one or more physiological parameters of one or more operators, wherein the one or more operators monitor the one or more operating parameters of the facility in order to take corrective measures for an alarm situation; a rule design module for detecting the alarm situation based on the one or more operating parameters; a sentient decision module for detecting a condition of one or more operators as either a fit condition or an unfit condition, and for deciding an alarm allocation based on the condition of the operator; and an alarm distribution module for distributing the alarm response based on the condition of the one or more operators.

As used herein, physiological parameters include any of physical conditions of one or more operators that can be measured. Exemplary parameters include, but are not limited to, temperature, blood pressure, pupil diameter, heart beat rate, breathing rate, perspiration, hyperventilation, brain patterns, and the like. The physiological parameters may be obtained from any physiological sensors that may be invasive or non-invasive. Exemplary invasive physiological sensors to measure, for example, temperature may be by the use of a thermometer. An example of non-invasive physiological sensor for measurement of temperature includes the use of thermocouples. Similarly, the use of an Electroencephalography (EEG) machine is a well-known invasive physiological sensor for measuring brain patterns to detect seizures, comatose states, and the like. Also, functional Magnetic Resonance Imaging (fMRI) equipment is a non-invasive physiological sensor for measuring brain activity.

The term invasive is used herein to indicate that the physiological parameter measurement technique involves the physiological sensor being present in the vicinity of the operator, and more often in contact with the operator. The term non-invasive is used herein to indicate that the physiological parameter measurement technique involves the physiological sensor being present away from the vicinity of the operator. While non-invasive physiological sensors provide greater advantages over the corresponding invasive physiological sensors, other considerations such as accuracy of measurements, economics of the device and method may deem the use of invasive physiological sensors appropriate.

The invasive physiological sensors used for measuring physiological parameters may be fitted as part of the operator's seating arrangement, as part of the operator's standard issue clothing, on the operator's workstation, and so on.

For example, a temperature sensor may be fitted onto the shirt to get a temperature reading from the common body locations such as armpit. Also, the operator's seat may comprise a pulse monitor which will give a clear indication of the operator's heart rate.

Further, the physiological sensors used for measuring physiological parameters, whether invasive or noninvasive may further be fitted with a communications means.

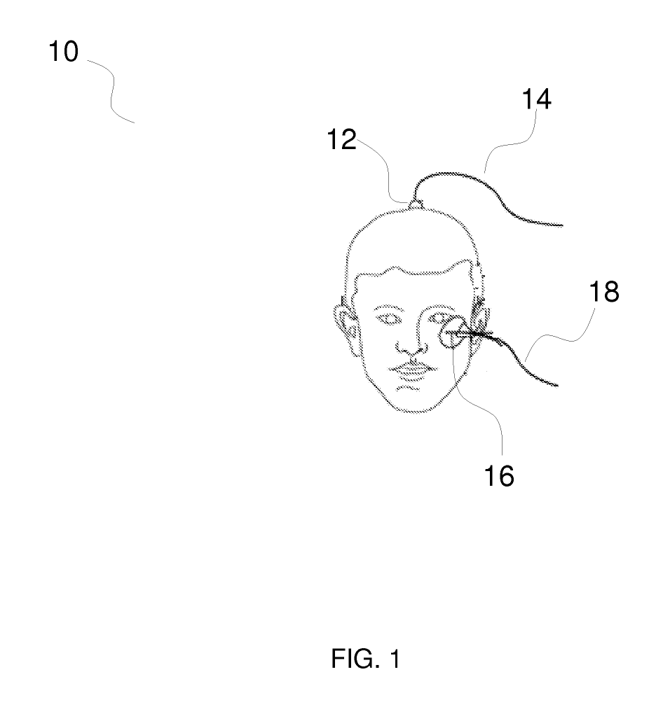

Referring to the drawings now, FIG. 1 shows an aspect of exemplary embodiment as disclosed herein, where the operator depicted by the numeral 10 is fitted with an electroencephalograph 12 on the operator's scalp. Further, the electroencephalograph is connected to a communicating means 14 to transmit data acquired from the electroencephalograph 12. In this exemplary embodiment, the communicating means is shown to be through a wired mechanism, but all possible forms of communication, including wireless through transmission of infrared, bluetooth, and the like are envisioned. Also, the communicating means may be configured to transmit data in analog form or in a digitized format. Further, a retinal scanner 16 is placed in front of the operator's eyes to measure pupil size. The retinal scanner is further attached to a communicating means 18.

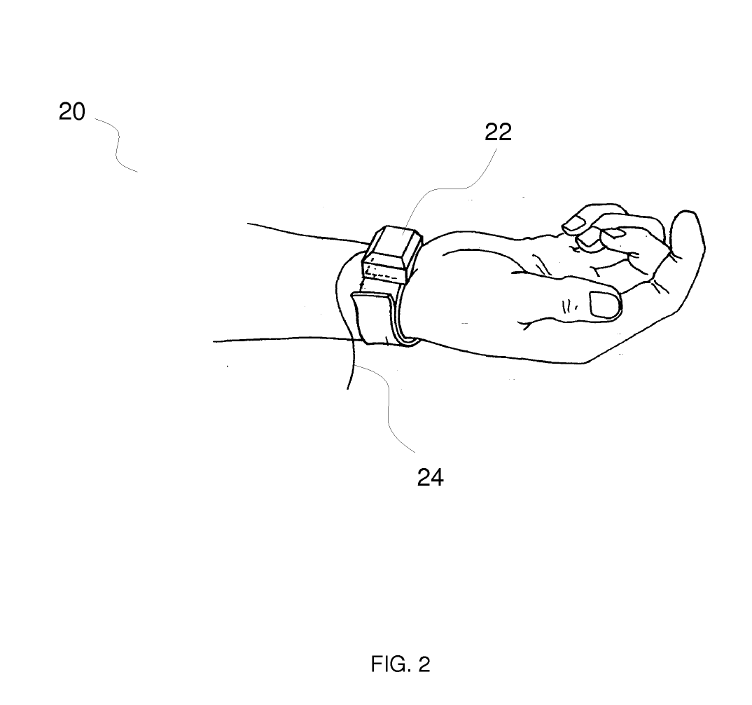

In another aspect of the exemplary embodiment, FIG. 2 shows an operator's arm 20 fitted with a blood pressure monitor 22 to obtain vasomotor data which is then connected to a communicating means 24. In this exemplary embodiment, an auscultation equipment is shown, but other forms of measurement are envisioned in this exemplary embodiment.

Physiological parameters of the operators are useful to determine a condition of the operators. For instance, an operator who is under a panic attack will show symptoms that include hyperventilation, shortness of breathing, perspiration, pupil dilation, feverish and the like. Thus, the measurement of these physiological parameters would immediately give an indication as to the mental state of this particular operator. An operator under a panic attack may, for example, be incapable of taking proper actions.

Similarly, an operator who is feeling very drowsy may show symptoms such as closed eyes, steady, rhythmic breathing, dropping head and shoulders, and so on. An operator in a drowsy or a sleepy state may not be in an alert state to carry out actions, and often, may require some lead time to be fully awake. Physiological parameters suitable for estimating this condition may include breathing rate, sound evaluation system for identifying snoring, pupil size, and the like.

In one aspect, an exemplary method is disclosed for determining the condition of an operator as being fit or unfit. A fit condition as used herein, may include states wherein the operator is fully alert and aware of the environment and is also in full control of all own motor and cognitive functions. In this condition, the operator is capable of handling any actions, including those involving routine and emergency tasks. Such tasks may also involve those that the operator has learnt by oneself, or those provided as part of training for the job, through a curriculum, and the like. A fit condition as used herein is also defined as fit with respect to understand a particular alarm condition or fit to respond to a particular alarm condition. The fit condition also includes the operator is physically present in and around the location where the alarm response is to be taken, also for example, deduced with physiological sensors.

An unfit condition may include states wherein the operator is under less than optimum mental and/or physical state, which may render the operator not to be in full control of oneself. In some situations, the operator may be aware of being in less than optimal state, such as when afflicted with a fever or a cold, or after having sustained an injury on a limb and the like, wherein the operator may take measures to overcome these states. In other situations, the operator may not be aware of being present in a certain state, such as when afflicted with a panic attack, or a drowsy state, and hence is incapable of taking corrective measures.

The determination of a condition of an operator as being fit or unfit also involves defining normal ranges of the physiological parameters. Any value of the physiological parameter for an operator that is within this normal range would render the operator as fit, while any value outside this range would render the operator as unfit. The normal range for any physiological parameter may be defined based on a statistical sample set of data obtained from a wide population distribution. The normal range of any physiological parameter may also be defined based on a study of the operator in question over a period of time, thus providing for each individual operator with a set of customized set of normal ranges. A combination of methods may also be used. Further, the normal range may be constantly updated depending on the amount of data made available. Those skilled in the art will recognize that each physiological parameter could have a different set of normal ranges. For example, an exemplary normal temperature range may be from about 37° C. to about 38° C., while an exemplary normal range for heart beat rate may be from about 50 beats per minute (bpm) to about 100 bpm, and an exemplary normal range for pupil diameter may between about 3 millimeters (mm) to about 5 mm.

The number of physiological parameters used to determine the condition of the operator can depend on various factors. Thus, in one exemplary embodiment, only one physiological parameter is used to determine the condition of the operator. A single physical parameter used to determine the condition of the operator may be, for example, heart beat rate. The sudden increase in heart beat rate may be due to various factors, such as a sudden panic attack, nervousness, hysteria and the like. In an exemplary embodiment, more than one physiological parameter can be used to determine the condition of the operator. Examples of the use of more than one physiological parameter may be the use of breathing rate, pupil size and heart beat rate. A certain combination of values for the aforementioned physiological parameters may, for example, indicate that the operator is in a sleepy or a drowsy state.

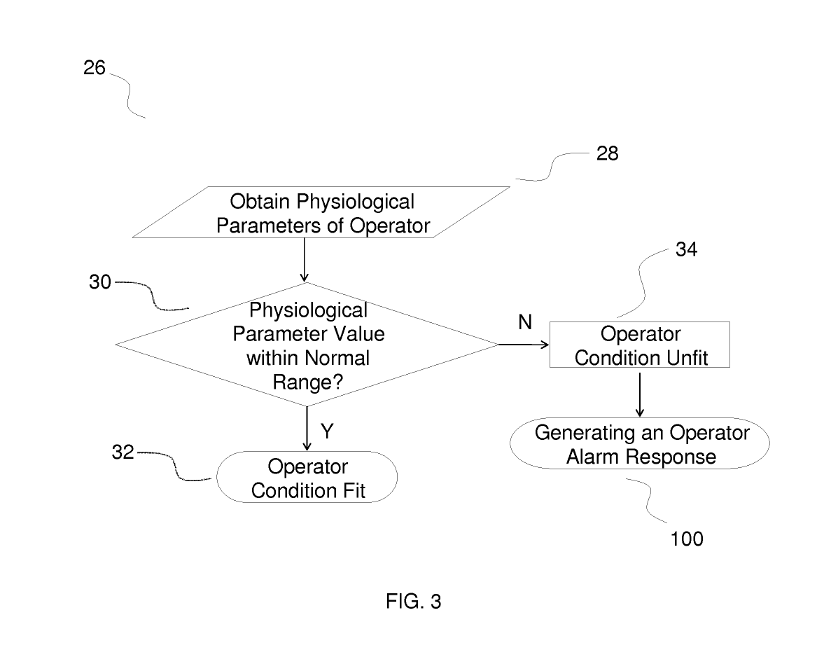

Referring to the drawings now, an exemplary flowchart to depict the condition of the operator is illustrated in FIG. 3. The method as shown in the flowchart referred by the numeral 26 begins by obtaining the physiological parameters of an operator in step 28. This value is then compared to the normal range for the physiological parameter being measured in step 30. If the value is within the normal range, then the condition of the operator is deemed as fit in step 32, else the condition of the operator is deemed as unfit in step 34. Further, once an operator has been found to be in an unfit condition, an operator alarm response may be generated in step 100. The operator alarm response besides flagging the operator condition as unfit, may also include means for making the operator fit by a suitable stimulus indicator. Exemplary suitable stimulus indicators include audible alerts to stimulate operators out of a drowsy state; display alerts such as flashing messages in appropriate colors; provide vibrations to the operator so as to make the operator alert; provide short bursts of benign electrical impulses designed to make the operator alert; or combinations thereof. This operator alarm response may be generated in a suitable location wherein other operators may be readily available to respond, or where another responsible party, such as a supervisor may be present to make any quick decisions and respond appropriately.

According to exemplary aspects of the presently disclosed technique, the operators described herein are responsible for operating equipment or machinery, monitoring and/or controlling the operations in a facility. The facility as described herein includes any area comprising equipment/machinery for example, but not limited to, computers, servers, electrical machinery, electronic equipment, mechanical parts, and any such equipment. Some exemplary facilities include a production plant, a factory, an electrical substation, an electrical distribution plant, a server room, and the like. Further, a production plant encompasses several types of plants, such as but not limited to, plastic production plant, steel plant, and so on. Each kind of facility may have various variables included in their regular functioning. As used herein, operating parameters of a facility refers to all the parameters that are to be constantly and/or periodically monitored to ensure smooth functioning of the facility. Some exemplary operating parameters used in a production facility include, but are not limited to, pressure of a reactor, temperature of a reactor, volume of liquid in a reactor, and the like. Some exemplary operating parameters in an electrical substation or an electrical distribution station may include, but are not limited to, high voltage, excess current, power tripping, and the like. Other operating parameters may be used in another environment, for example level of a fluid or flow of a fluid.

The operating parameters can, for example, have predetermined normal ranges. Any time a measurement of any of the operating parameters provides a value that falls outside this range will be deemed to have resulted in an alarm situation. During an alarm situation, an alarm response has to be generated to ensure no dire consequences ensue.

Alarm situations may be classified into Critical, High Priority, Medium Priority and Low Priority alarm situations. The factors used to classify the alarm situation into different categories depend on several factors, such as the nature of the parameter, nature of the facility, deviation from the normal range, and the like. The classification of alarm situations into various categories may be done manually, or may be automated. In some instances, the classification may be automated with the possibility of a manual override whenever desired.

Depending on the classification of the alarm situation, a different alarm response may be desired. The alarm response mentioned herein includes determining the alarm based on set safety standards, escalation and over-riding rules, and any delay/wait allowed for any alarm situation. The alarm response may be an automated response through the use of an automated response module. Often times, though, an alarm response is handled through the intervention of an operator. Thus, it can be specified that the operator involved in a particular alarm situation is in a fit condition. Therefore, exemplary aspects of the present method can add to the existing alarm management techniques by ensuring that fit operators are selected to handle the alarm situations.

In one aspect, an exemplary method is provided to determine the condition of the one or more operators and decide those operators who are in a fit condition, and based on the condition of the operator, the technique provides for distribution of an alarm response to those operators who are in a fit condition.

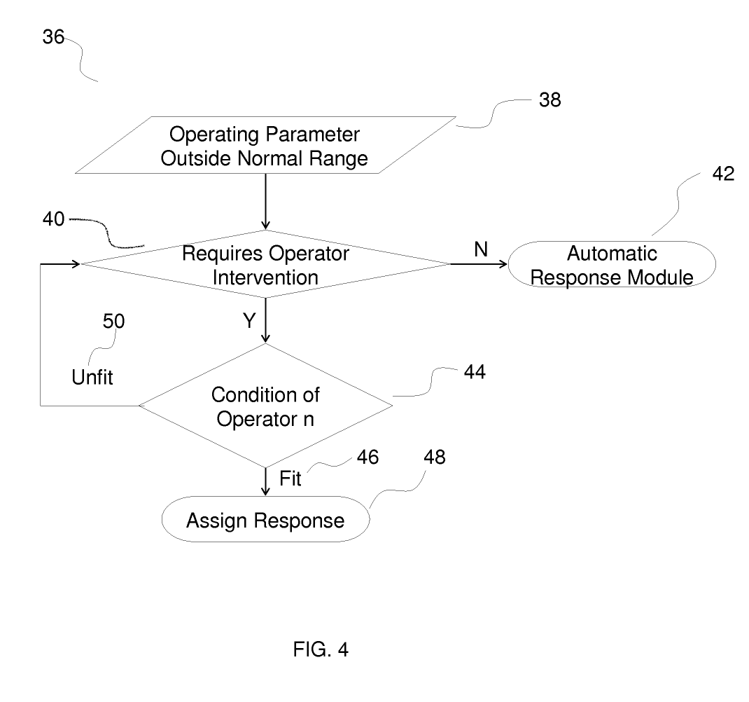

Referring to the drawings, an exemplary method as described herein is depicted in FIG. 4 in the form a flowchart referred by the numeral 36. In the first step represented herein by numeral 38, the operating parameters of a facility are detected to be having a value outside the normal range, and hence the situation is determined to be an alarm situation involving an alarm response. In the next step 40, the need for an operator response is determined. If it is deemed that no operator response is appropriate, then step 42 is performed wherein an automatic response module is invoked. Otherwise, in step 44, the condition of the operator is then determined to ensure whether the operator is in a fit condition 46. If the operator is in a fit condition, then alarm response is assigned to that particular operator in step 48. If the operator is found to be unfit condition 50, then the condition of the next appropriate operator is determined in step 44. It is understood that not all operators are qualified for all alarm responses, and that some may be trained for certain alarm responses, while others may be trained for other alarm responses. Thus, in one embodiment, the set of operators to be assigned for a given alarm response is to be predetermined. Further, a priority number for the operators assigning the responses may also be given. In this situation, the condition of the operators are determined in the predetermined order, until the first operator in a fit condition is found, who is then assigned the task of alarm response. If no operators are found to be in a fit response, then an appropriate automatic response may be invoked. Alternately, a general alarm can be provided to alert everyone in the vicinity.

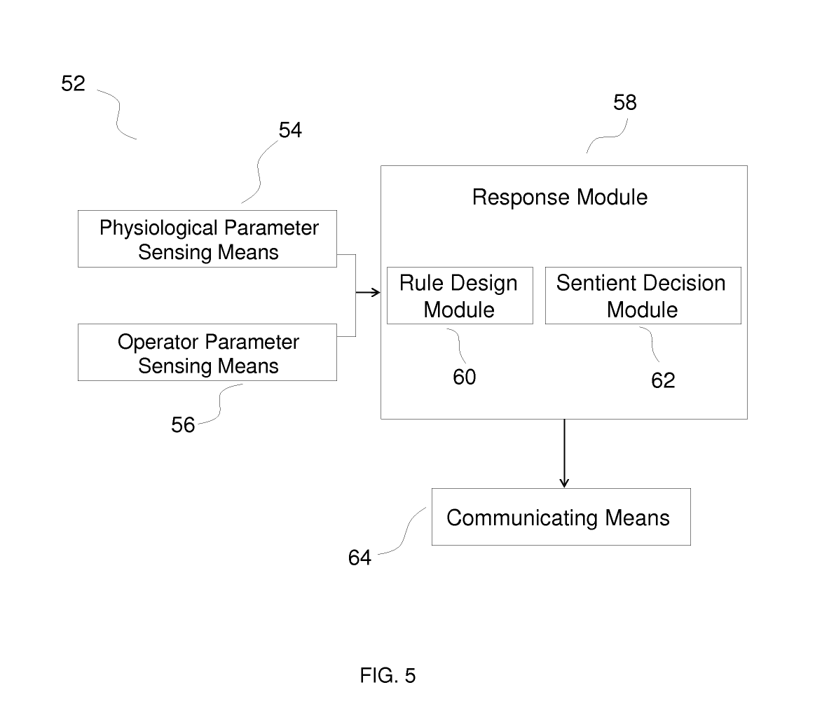

In another aspect, an exemplary intelligent alarm device is disclosed for generating and distributing the alarm response. FIG. 5 shows one exemplary embodiment of the intelligent alarm device 52. The device 52 includes a first sensing means 54 (e.g., a sensor device as disclosed herein) to sense one or more physiological parameters of one or more operators. The first sensing means may be configured to receive and process the input from one or more physiological parameter sensors. Alternately, the first sensing means may comprise at least one physiological parameter sensor, and a module to receive and process the input from the aforementioned physiological parameter sensor. The sensing means have been discussed in reference to FIG.1 and FIG. 2. Based on the input from the first sensing means, a decision as to whether the condition of the one or more operators is fit or unfit will be made by the intelligent alarm device 52.

An exemplary intelligent alarm device 52 may comprise a second sensing means 56 (e.g., another sensor as disclosed herein) for one or more operating parameters of a facility. The second sensing means may be configured to receive and process the input from one or more operating parameter sensors. Alternately, the second sensing means may comprise at least one operating parameter sensor, and a module to receive and process the input from the aforementioned operating parameter sensor. Examples of an operating parameter sensor include but are not limited to thermometers, thermocouples, barometers, manometers, volume sensors, ammeters, volt meters, power sensors, amplitude sensors, and the like. As mentioned earlier, whenever the values received from the one or more operating parameters fall outside the normal range, an alarm situation is said to have occurred. The device may also be configured to respond to the alarm situation. This may be achieved through the use of a response module 58 located, for example, within the intelligent alarm device. The response module may be configured to respond by finding an operator in a fit condition. An exemplary response module may comprise rule design module 60. The rule design module can comprise several instructions regarding the various alarm situations such as but not limited to, all possible responses, prioritization information, rationalization information, logic for determining whether to provide an automatic response or an operator intervention response, appropriate operators for a given alarm situation, order of assigning operators for a given alarm situation, nature of information to be provided to operator, manner of presentation of information to operator, data storage and the like. In an exemplary embodiment, the response module 58 is configured to provide the response. In some embodiments, the response module may also be configured to respond to the alarm response through an automated response module, not shown in the FIG. 5. The automated response module may have some preprogrammed action items, which may be triggered by the appearance of an alarm situation. In another embodiment, the response module then transmits the relevant information based on the rule design module 60 to a sentient decision module 62, which is configured to determine the alarm situation priority, condition of one or more operators, the nature of information, presentation of the information, and the like.

An exemplary intelligent alarm device may comprise a communicating means 64 to notify the appropriate operator in a fit condition. The means of communication may be in the form of a flashing light, a sound such as a siren, through a beeper, an automatic messaging system sent through a telecommunication device, an automatic voice message sent through a telecommunication device such a mobile phone, and so on.

It is also to be understood that it is possible to integrate several aspects of the device into a single device. For instance, the first sensing means and the second sensing means may be integrated into a single device. In another instance, the first and second sensing means, along with the rule design module may be made available as a single device. In yet another instance, the first and second sensing means, the rule design module, and the sentient decision module may be integrated into a single device. In a further instance, the first and second sensing means, the rule design module, the sentient decision module and the communication means may be integrated into a single device. The ability to integrate several modules into a single device depends on various factors, such as, but not limited to, the size of the device, the circuitry involved, the amount of information and logic to be stored onto the circuitry, the extent of storage necessary, and the like. Further, the device is also envisioned to be part of an alarm management system of a facility. It may be noted here that the intelligent alarm device may be integrated in the existing process automation systems to function in collaboration or through the process automation system. Also, it may be noted that the device in part or in totality exists as software or hardware component.

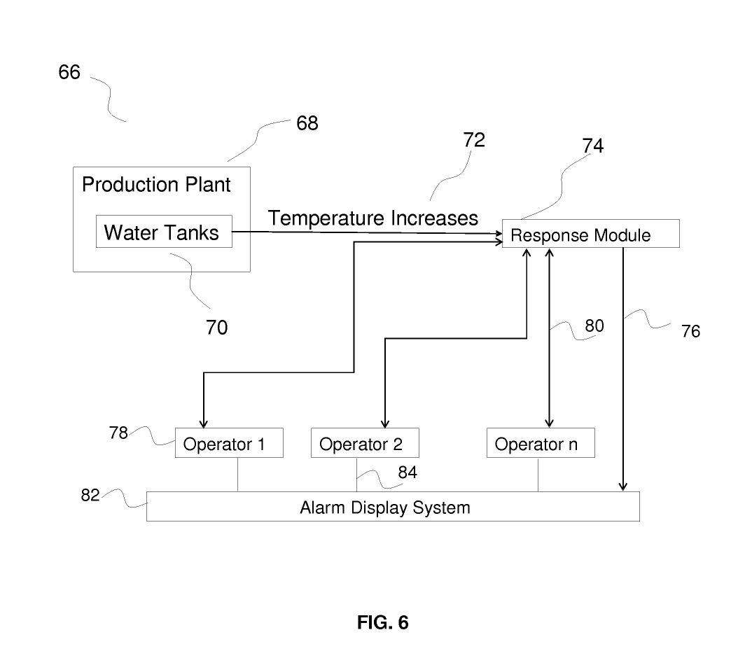

FIG. 6 shows an example of one real life situation wherein a method and a device configured according to exemplary techniques would be useful. In one exemplary embodiment 66, a production plant 68 comprises water tanks 70, which are to be maintained at a particular temperature range. Whenever the operating parameter sensing means (for example, a thermocouple) senses the temperature to have increased above the range 72, the response module 74 is invoked to generate an alarm response 76 The response module 74 also receives information on condition of the operators, shown generally as operator 1, operator 2 . . . operator n, and referenced by reference numeral 78 who have been assigned the task of maintaining the temperature within a particular range. The response module 74 via a communication link 80 receives this information and processes this information as explained with reference to FIG. 5, and determines the operator in fit condition and the alarm response 76 is assigned to the operator in fit condition via an alarm display device 82.

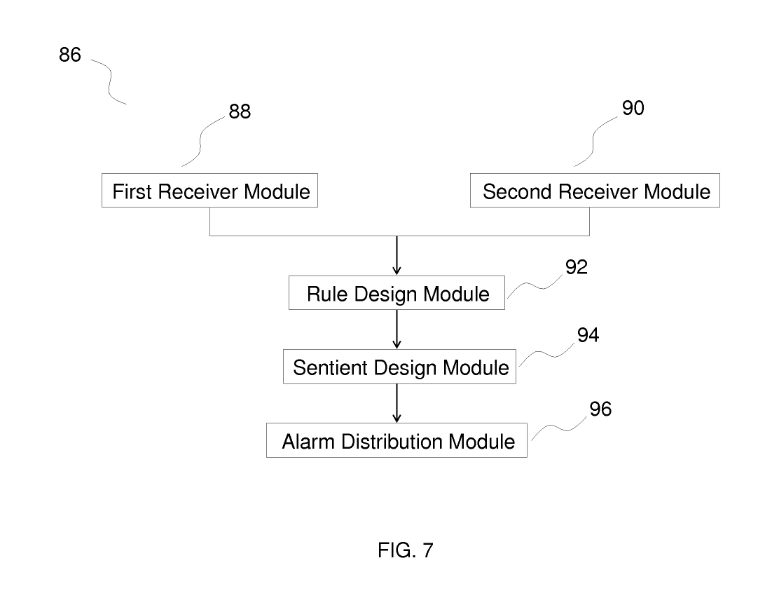

In another aspect, as shown in FIG. 7, a processor is provided for an alarm management system in the form of a block diagram. An exemplary processor is depicted by the numeral 86 and includes a first receiver module 88 configured for receiving one or more operating parameters of a facility. The processor can comprise a second receiver module 90 configured for receiving one or more physiological parameters of one or more operators, where the one or more operators monitor the one or more operating parameters of the facility in order to take corrective measures for an alarm situation. The processor can comprise a rule design module 92 for detecting the alarm situation based on the one or more operating parameters. The rule design module can comprise several instructions regarding the various alarm situations such as but not limited to, all possible responses, prioritization information, rationalization information, logic for determining whether an automatic response or an operator intervention response, appropriate operators for a given alarm situation, order of assigning operators for a given alarm situation, nature of information to be provided to operator, manner of presentation of information to operator, data storage and the like. In an exemplary embodiment, the response module is configured to provide the alarm response. In some embodiments, the response module may also be configured to respond to the alarm response through an automated response module, not shown in the figure. The automated response module may have some preprogrammed action items, which may be triggered by the appearance of an alarm situation. The processor comprises a sentient decision module 94 for detecting a condition of one or more operators as either a fit condition or an unfit condition, and for deciding an alarm allocation based on the condition of the operator. The sentient decision module can also be configured to decide the nature of information, presentation of the information, and the like. An exemplary processor can also comprise an alarm distribution module 96 for distributing the alarm response based on the condition of the one or more operators, that ensures that the alarm response is distributed to fit operator(s).

The methods, devices and the systems disclosed herein may, for example, be advantageously used to determine the conditions of an operator to ensure that the operator is in a position to adequately respond to any situation. It may be applicable to various situations such as but not limited to, automobile operation wherein the driver is an operator, aircraft operation wherein the pilot and other cabin crew members are one or more operators, production plants wherein the foreman, plant operators, and the like. In all these facilities, alarm situations can frequently arise due to various factors. In such situations, the conditions of the operators can be important in terms of appropriately handling the situations. Embodiments described herein can be very useful in determining the condition of the operators, and appropriately assigning the alarm response tasks. In particular, the disclosed embodiments can be useful in facilities such as production plants, electrical substations, electrical distribution plants, and the like, wherein the number of alarm situations within a given period of time can be quite high.

Only certain features of the invention have been specifically illustrated and described herein, and many modifications and changes will occur to those skilled in the art. The appended claims are intended to cover all such modifications and changes which fall within the spirit of the invention.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. A method for alarm distribution, the method comprising;
receiving one or more physiological parameters of one or more operators;
detecting a condition of the one or more operators based on the one or more physiological parameters;
assessing the condition of the one or more operators; and
generating an operator alarm response based on an assessed condition of the one or more operators.

2. The method of claim 1, wherein the one or more physiological parameters of the one or more operators are obtained from one or more physiological sensors.

3. The method of claim 1, wherein the condition of the one or more operators is either a fit condition or an unfit condition.

4. The method of claim 1, comprising:
recognizing an alarm situation.

5. The method of claim 1, comrising:
generating an alarm response to at least one fit operator or having an automatic response module handle the alarm situation.

6. A process automation system comprising:
means for receiving one or more physiological parameters of one or more operators, detecting a condition of the one or more operators based on the one or more physiological parameters, and assessing the condition of the one or more operators; and
means for generating an operator alarm response based on an assessed condition of the one or more operators.

7. An intelligent alarm device comprising:
a first sensing means for sensing one or more physiological parameters of one or more operators, the physiological parameters being representative of a condition of the one or more operators; and
a processor configured to receive and process the one or more physiological parameters, and to assess the condition of the one more operators for generating an operator alarm.

8. The process automation system of claim 6, wherein the receiving means and the generating means constitute an intelligent alarm device for alarm management.

9. An automation system for alarm management in a facility, the automation system comprising:
a first receiver module configured for receiving one or more operating parameters of the facility;
a rule design module for detecting an alarm situation based on the one or more operating parameters;
a second receiver module configured for receiving one or more physiological parameters of one or more operators, wherein the one or more operators monitor the one or more operating parameters of the facility in order to take corrective measures for an alarm situation;
a sentient decision module for detecting a condition of one or more operators as either a fit condition or an unfit condition, and for deciding upon alarm allocation based on the condition of the operator; and
an alarm distribution module for distributing an alarm response based on the condition of the one or more operators.

10. The automation system of claim 9, wherein the alarm distribution module is configured to distribute the alarm response to one or more operators in the fit condition or to an automatic response module.

11. The intelligent alarm device of claim 7, wherein the first sensing means is one or more physiological sensors.

12. The intelligent alarm device of claim 7, wherein the condition is a fitness condition of one or more operators.

13. The intelligent alarm device of claim 7, wherein the processor is configured to recognize an alarm condition to generate an alarm response to a fit operator or to an automatic rsponse module.

14. The automation system of claim 9, in combination with one or more physiological sensors.
